(19) United States
(12) Patent Application Publication
(10) Pub. No.: US 2023/0054389 A1
(43) Pub. Date: Feb. 23, 2023

(54) THREE-DIMENSIONAL SHAPE REGISTRATION METHOD AND THREE-DIMENSIONAL SHAPE DATA PROCESSING DEVICE

(71) Applicant: Shimadzu Corporation, Kyoto-shi (JP)

(72) Inventors: Shuhei ONISHI, Kyoto-shi (JP); Hiroyuki FUJIMOTO, Kyoto-shi (JP)

(73) Assignee: Shimadzu Corporation, Kyoto-shi (JP)

(21) Appl. No.: 17/879,099

(22) Filed: Aug. 2, 2022

(30) Foreign Application Priority Data
Aug. 18, 2021 (JP) 2021-133598

(51) Int. Cl. G06T 7/00; G06T 7/33; G06T 7/73; G01N 23/046

(52) U.S. Cl. CPC G06T 7/001; G06T 7/337; G06T 7/74; G01N 23/046; G06T 2207/10081; G06T 2207/30136; G01N 2223/401; G01N 2223/419

(57) ABSTRACT

A three-dimensional shape registration method includes a step of acquiring three-dimensional CT data of a subject and at least three positioning members, which are acquired by performing X-ray CT imaging on the positioning members together with the subject, a step of measuring relative positions between the subject and each of the positioning members, and a step of performing registration between the subject in the CT data and the subject in three-dimensional design data of the subject based on the CT data, the design data, and information on the relative positions.

### CROSS-REFERENCE TO RELATED APPLICATIONS

The priority application number JP2021-133598, THREE-DIMENSIONAL SHAPE REGISTRATION METHOD AND THREE-DIMENSIONAL SHAPE DATA PROCESSING DEVICE, filed on Aug. 18, 2021, ONISHI Shuhei, FUJIMOTO Hiroyuki, upon which this patent application is based are hereby incorporated by reference.

### BACKGROUND OF THE INVENTION

### Field of the Invention

The present invention relates to a three-dimensional shape registration method and a three-dimensional shape data processing device, and more particularly, to a three-dimensional shape registration method and a three-dimensional shape data processing device for performing registration between a subject in CT data acquired by X-ray CT imaging and a subject in three-dimensional design data.

### Background Art

In the related art, there is known a three-dimensional shape registration method for performing registration between a subject in CT data acquired by X-ray CT imaging and a subject in three-dimensional design data. Such a three-dimensional shape registration method is disclosed in, for example, Japanese Patent Application Laid-Open No. 2020-8360.

Here, regarding the CT data acquired by performing the X-ray CT imaging, there are cases where the accuracy of a surface of the subject is high, but the accuracy of individual points is not high. That is, depending on a shape of the subject, there may be a portion where the accuracy of the shape in the CT data is decreased. Therefore, there is a problem that it may be difficult to accurately perform the registration between the subject in the CT data and the subject in the design data due to the shape of the subject.

### SUMMARY OF THE INVENTION

The present invention has been made to solve the above-mentioned problems, and one object of the present invention is to provide a three-dimensional shape registration method and a three-dimensional shape data processing device capable of accurately performing registration between a subject in CT data and a subject in design data without depending on a shape of the subject.

In order to achieve the above object, a three-dimensional shape registration method in a first aspect of the present invention includes a step of acquiring three-dimensional CT data of a subject and at least three positioning members, which are acquired by performing X-ray CT imaging on the positioning members together with the subject, a step of measuring relative positions between the subject and each of the positioning members, and a step of performing registration between the subject in the CT data and the subject in three-dimensional design data of the subject based on the CT data, the design data, and information on the relative positions.

A three-dimensional shape data processing device in a second aspect of the present invention includes a data acquisition unit that acquires three-dimensional CT data of a subject and at least three positioning members, which are acquired by performing X-ray CT imaging on the positioning members together with the subject, a relative position information acquisition unit that acquires information on relative positions between the subject and each of the positioning members, and a registration unit that performs registration between the subject in the CT data and the subject in three-dimensional design data of the subject based on the CT data, the design data, and the information on the relative positions.

In the three-dimensional shape registration method in the first aspect and the three-dimensional shape data processing device in the second aspect, the registration between the subject in the CT data and the subject in the design data is performed based on the CT data, the three-dimensional design data of the subject, and the information on the relative positions between the subject and each of the positioning members. Thereby, the position information on the positioning member in the design data can be acquired based on the design data and the information on the relative position. Therefore, when the registration between the subject in the CT data and the subject in the design data is performed, it is possible to perform the registration for the subject of each data by performing the registration between the positioning member in the CT data and the positioning member in the design data. Therefore, for example, by using the positioning member having a shape capable of accurately acquiring the shape in the CT data, the registration between the subject in the CT data and the subject in the design data can be performed without depending on the shape of the subject. As a result, the registration between the position of the subject in the CT data and the position of the subject in the design data can be accurately performed without depending on the shape of the subject.

### BRIEF DESCRIPTION OF THE DRAWINGS

FIG. 1 is a block diagram illustrating a three-dimensional shape data processing system including a three-dimensional shape data processing device according to the present embodiment.

FIG. 2 is a diagram illustrating an example of an X-ray CT imaging device.

FIG. 3 is a diagram illustrating an example of a subject.

FIG. 4 is a functional block diagram for describing functions of a processor of the three-dimensional shape data processing device.

FIG. 5 is a flowchart for describing an operation of processing of the three-dimensional shape data processing device according to the present embodiment.

FIG. 6 is a flowchart for describing the details of processing of disposing a positioning member with respect to the subject.

FIG. 7 is a diagram for describing the subject in which the positioning member is disposed.

FIG. 8 is a diagram for describing the disposition of the three positioning members.

FIG. 9 is a diagram for describing the disposition of at least two of the positioning members.

FIG. 10 is a flowchart for describing the details of processing of measuring a relative position.

FIG. 11 is a diagram for describing the details of the processing of measuring the relative position.

FIG. 12 is a flowchart for describing the details of processing of acquiring first position information.

FIG. 13 is a diagram for describing the details of the processing of acquiring the first position information.

FIG. 14 is a flowchart for describing the details of processing of acquiring second position information.

FIG. 15 is a diagram for describing the details of the processing of acquiring the second position information.

FIG. 16 is a flowchart for describing the details of processing of registration by a registration unit.

FIG. 17 is a diagram for describing the details of the processing of the registration by the registration unit.

FIG. 18 is a diagram for describing a method of fixing the positioning member according to a first modification example.

FIG. 19 is a diagram for describing a method of fixing the positioning member according to a second modification example.

FIG. 20 is a diagram for describing a disposition of the positioning member with respect to the subject according to a third modification example.

### DETAILED DESCRIPTION OF THE INVENTION

Hereinafter, embodiments embodying the present invention will be described with reference to the drawings.

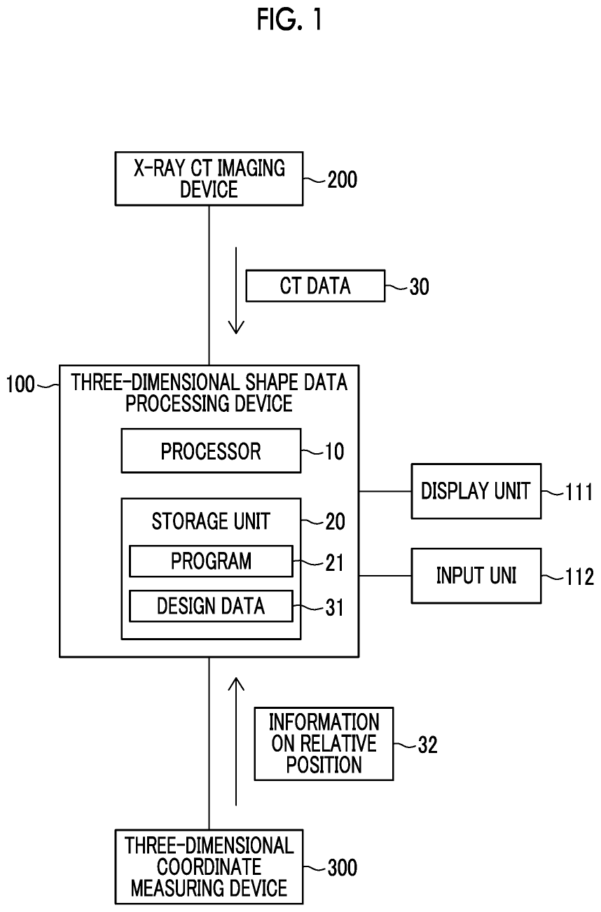

A three-dimensional shape data processing system including a three-dimensional shape data processing device 100 according to the present embodiment will be described with reference to FIGS. 1 to 17.

Overview of Three-Dimensional Shape Data Processing System

The three-dimensional shape data processing system includes a three-dimensional shape data processing device 100, an X-ray CT imaging device 200, and a three-dimensional coordinate measuring device 300. The three-dimensional shape data processing system performs registration between a subject 90 in the CT data 30 (see FIG. 3) and a subject 90 in the design data 31 by using the CT data 30 generated by the X-ray CT imaging device 200, the information 32 on a relative position acquired by the three-dimensional coordinate measuring device 300, and the design data 31 stored in the three-dimensional shape data processing device 100.

Three-Dimensional Shape Data Processing Device

The three-dimensional shape data processing device 100 illustrated in FIG. 1 is a device that processes three-dimensional data of the subject 90. Specifically, the three-dimensional shape data processing device 100 performs processing of the registration between the subject 90 in the three-dimensional CT data 30 obtained by CT imaging the subject 90 and the X-ray CT imaging device 200 and the subject 90 in the three-dimensional design data 31. That is, in the three-dimensional shape data processing device 100 according to the present embodiment, it is inspected whether the subject 90 is manufactured according to the design data 31 by performing the registration between the subject 90 in the CT data 30 and the subject 90 in the design data 31. The design data 31 is design data created for manufacturing the subject 90. The design data 31 may be, for example, three-dimensional computer aided design (CAD) data.

The three-dimensional shape data processing device 100 is the so-called personal computer and includes a processor 10 and a storage unit 20. Further, a display unit 111 and an input unit 112 are connected to the three-dimensional shape data processing device 100. The display unit 111 is, for example, a liquid crystal display device. The display unit 111 may be an electroluminescence display device, a projector, or a head-mounted display. The input unit 112 is an input device including, for example, a mouse and a keyboard. The input unit 112 may be a touch panel.

The processor 10 is composed of a central processing unit (CPU), a field-programmable gate array (FPGA), an application specific integrated circuit (ASIC), and the like. When the processor 10 executes a predetermined program 21, arithmetic processing is performed as the three-dimensional shape data processing device 100.

The storage unit 20 includes a non-volatile storage device. The non-volatile storage device is, for example, a hard disk drive, a solid state drive, or the like. Various programs 21 executed by the processor 10 are stored in the storage unit 20. Further, the storage unit 20 stores the three-dimensional design data 31 of the subject 90.

Here, the CT data 30 can convert the internal structure of the subject 90 into three-dimensional data. Although the data on the surface of the subject 90 can be accurately acquired, there is a possibility that the accuracy may decrease at individual points. That is, when the registration is performed for the individual points of the CT data 30, there are cases where it is difficult to accurately perform the registration between the subject 90 in the CT data 30 and the subject 90 in the design data 31.

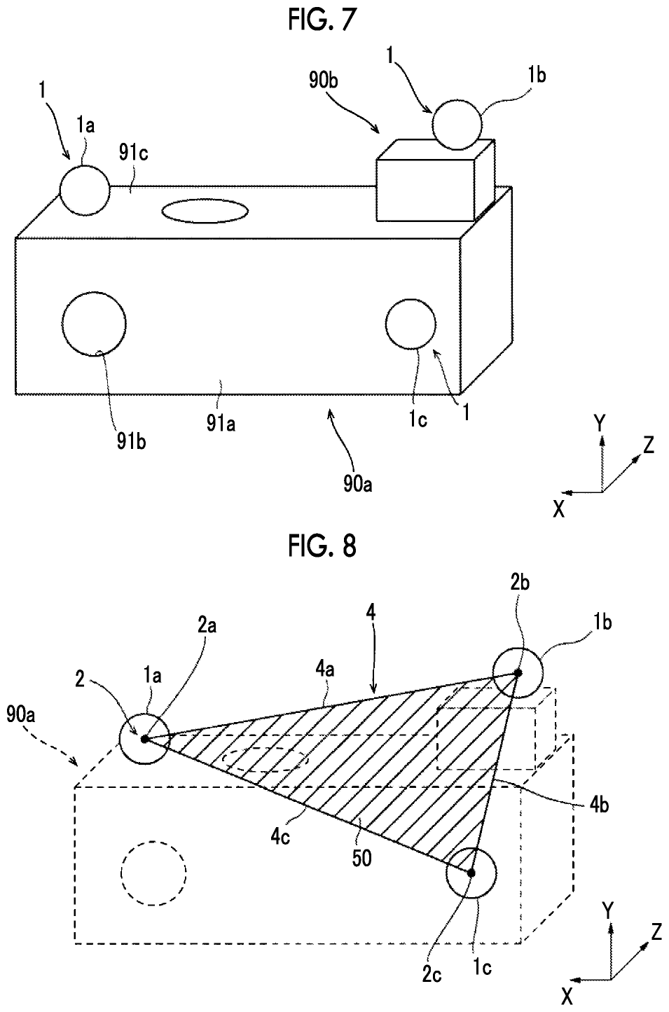

Therefore, in the present embodiment, by performing the X-ray CT imaging in a state in which the positioning member 1 (see FIG. 7) disposed with respect to the subject 90, the CT data 30 of the subject 90 and the positioning member 1 is acquired. Further, a relative position of the positioning member 1 disposed on the subject 90 with respect to the subject 90 is measured by the three-dimensional coordinate measuring device 300. The three-dimensional shape data processing device 100 performs the registration between the subject 90 in the CT data 30 and the subject 90 in the design data 31 based on the CT data 30 generated by the X-ray CT imaging device 200, the design data 31, and the information 32 on the relative position measured by the three-dimensional coordinate measuring device 300.

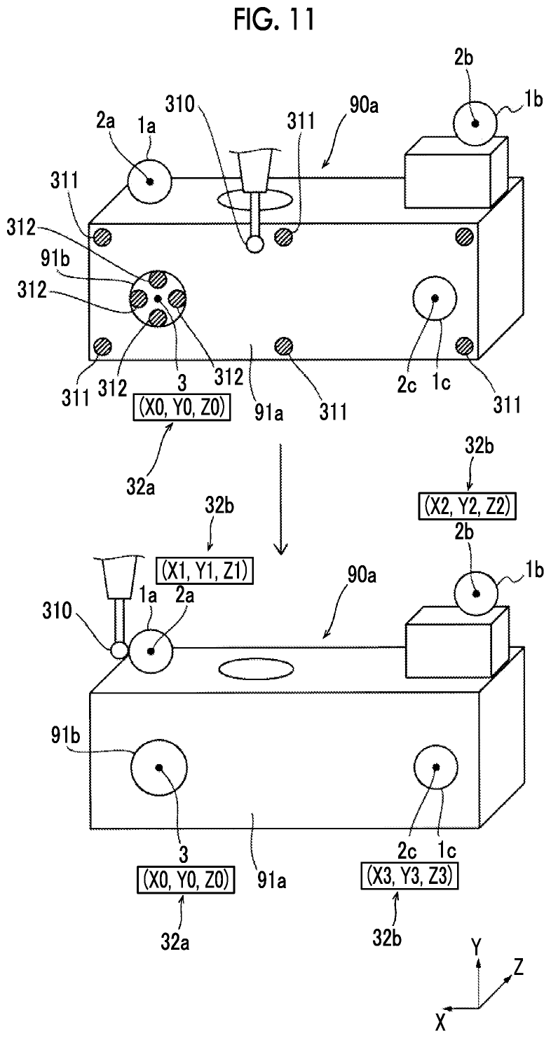

Examples of the three-dimensional coordinate measuring device 300 include a contact type measuring device that measures by making a probe 310 (see FIG. 11) contact with a measurement target such as the subject 90 and a non-contact type measuring device that measures by irradiating the measurement target with laser light or the like. In the present embodiment, the three-dimensional coordinate measuring device 300 is a contact type measuring device. That is, the three-dimensional coordinate measuring device 330 is a device that acquires position coordinates of a plurality of positions in contact with the probe 310 and acquires information on the three-dimensional shape of the subject 90 by combining the position coordinates. The probe 310 is a contactor that is in contact with the subject 90.

X-Ray CT Imaging Device

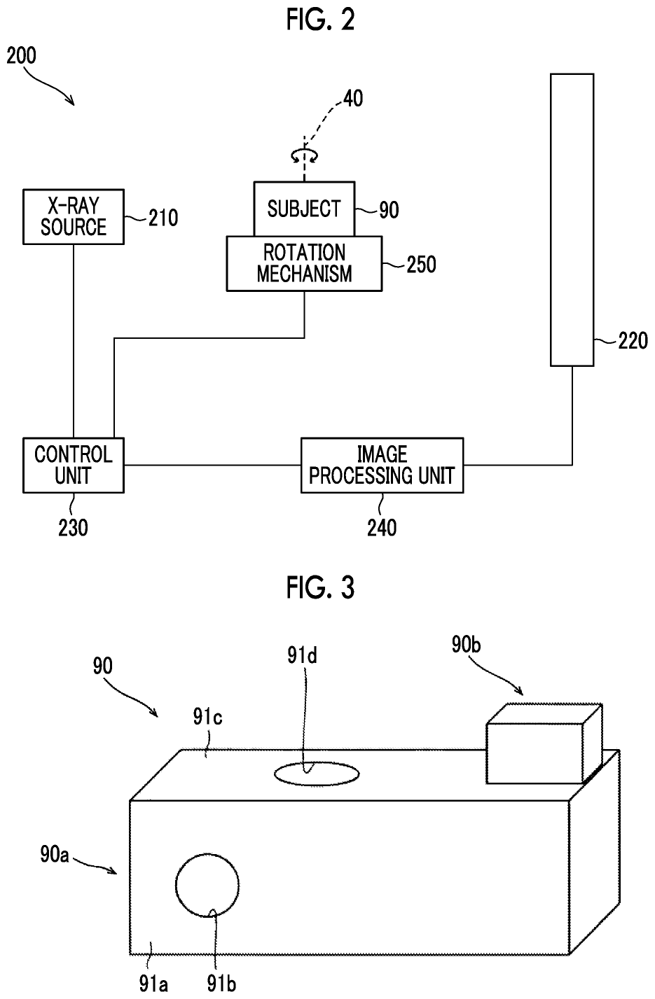

As illustrated in FIG. 2, the X-ray CT imaging device 200 includes an X-ray source 210, an X-ray detector 220, a control unit 230, an image processing unit 240, and a rotation mechanism 250.

The X-ray source 210 is configured to irradiate the subject 90 with X-rays. Specifically, the X-ray source 210 is configured to generate X-rays by colliding electrons generated by applying a high voltage to the electrodes with a target. The X-ray source 210 is, for example, an X-ray generation device including an X-ray tube and a power source.

The X-ray detector 220 is configured to detect the X-ray with which the subject 90 is irradiated from the X-ray source 210. Further, the X-ray detector 220 is configured to convert the detected X-ray into an electric signal (an image signal). The X-ray detector 220 includes a light receiving unit that receives the X-ray and a conversion unit that converts the received X-ray into an image signal. The X-ray detector 220 is, for example, a flat panel detector (FPD). The X-ray detector 220 is composed of a plurality of conversion elements (not illustrated) and pixel electrodes (not illustrated) disposed on the plurality of conversion elements. The image signal of the X-ray detector 220 is transmitted to the image processing unit 240.

The control unit 230 is configured to control the X-ray source 210 and the rotation mechanism 250. The control unit 230 includes a processor composed of a CPU, RAM, ROM, and the like.

The image processing unit 240 is configured to control the X-ray detector 220. Further, the image processing unit 240 is configured to acquire X-ray image data based on the X-rays detected by the X-ray detector 220. Further, the image processing unit 240 is configured to generate the CT data 30 based on a plurality of X-ray image data acquired by imaging the subject 90 with the rotation mechanism 250 while rotating the subject 90 around an axis line 40. The image processing unit 240 includes a processor such as a CPU, a GPU, an FPGA, and an ASIC. The image processing unit 240 is configured with software as a functional block realized by the processor executing various programs. The image processing unit 240 may be configured with hardware by providing a dedicated processor (processing circuit) in the X-ray CT imaging device 200.

The rotation mechanism 250 is configured to rotate the subject 90 around the axis line 40. The rotation mechanism 250 includes a mounting portion on which the subject 90 is mounted, a rotating portion for rotating the mounting portion, and a driving portion for applying a driving force to the rotating portion. The rotating portion includes, for example, a pulley for transmitting the driving force from the driving portion. Further, the driving portion includes, for example, a motor.

Subject

FIG. 3 is a diagram illustrating an example of the subject 90. The subject 90 includes a resin product made of a resin material, a metal product made of a metal material, or the like. A manufacturing method of the subject 90 is not limited. In the present embodiment, the subject 90 is made of, for example, aluminum.

FIG. 3 illustrates an example of a single component in which a rectangular parallelepiped 90a and a rectangular parallelepiped 90b are integrally formed as the subject 90 for convenience. A circular hole 91b is provided on a first surface 91a of the subject 90. Further, a circular hole 91d is provided on a second surface 91c, which is a surface different from the first surface 91a of the subject 90.

Positioning Member

The positioning member 1 has an isotropic shape. Specifically, the positioning member 1 has a spherical shape as the isotropic shape. Further, the positioning member 1 is made of a material having an X-ray transmittance which is the same or similar to the subject 90. The positioning member 1 includes, for example, a sphere made of ceramics. The isotropic shape means that the shape of the positioning member 1 has no directivity. In other words, it means that there is little difference in a path length of the X-rays transmitted through the positioning member 1 at each rotation angle even in a case where the positioning member 1 is rotated by the rotation mechanism 250 when performing the X-ray CT imaging with the X-ray CT imaging device 200.

Detailed Configuration of Three-Dimensional Shape Data Processing Device

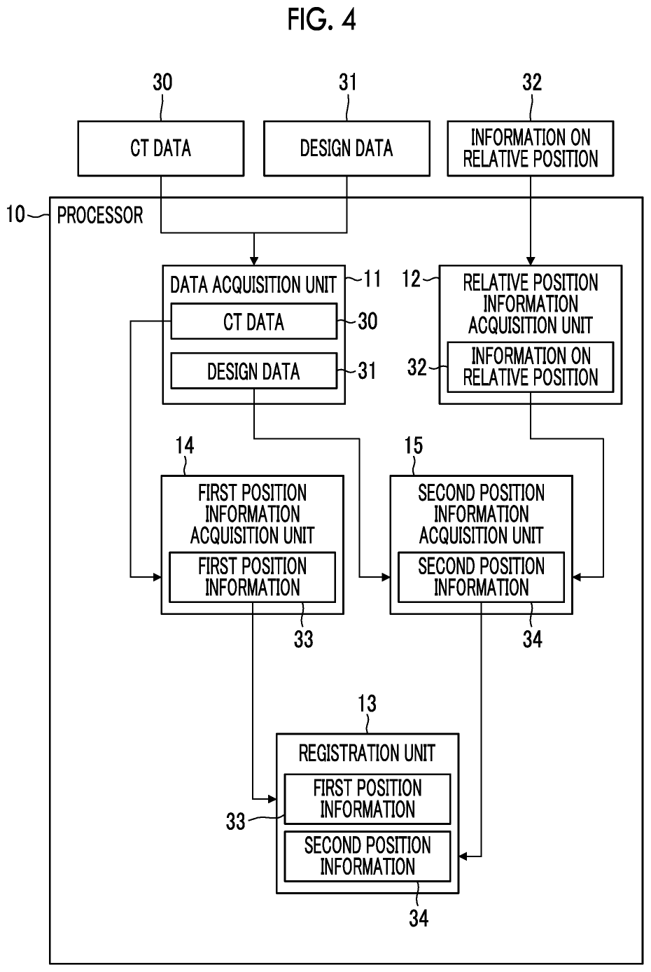

FIG. 4 is a block diagram illustrating an outline of each configuration in which the three-dimensional shape data processing device 100 performs the registration between the subject 90 in the CT data 30 and the subject 90 in the design data 31.

The processor 10 of the three-dimensional shape data processing device 100 includes a data acquisition unit 11, a relative position information acquisition unit 12, a registration unit 13, a first position information acquisition unit 14, a second position information acquisition unit 15, and the like as functional blocks. In other words, by executing the program 21 stored in the storage unit 20, the processor 10 functions as the data acquisition unit 11, the relative position information acquisition unit 12, the registration unit 13, the first position information acquisition unit 14, and the second position information acquisition unit 15.

The data acquisition unit 11 has a function of acquiring the three-dimensional CT data 30 of the subject 90 and the positioning members 1 acquired by performing the X-ray CT imaging on at least three positioning members 1 (see FIG. 7) together with the subject 90 (see FIG. 3). The data acquisition unit 11 acquires the CT data 30 transmitted from the X-ray CT imaging device 200 via a network. When the CT data 30 is stored in the storage unit 20, the data acquisition unit 11 may read the CT data 30 from the storage unit 20. Further, the data acquisition unit 11 acquires the design data 31 by reading the design data 31 stored in the storage unit 20 (see FIG. 1). The data acquisition unit 11 outputs the acquired CT data 30 to the first position information acquisition unit 14. Further, the data acquisition unit 11 outputs the acquired design data 31 to the second position information acquisition unit 15.

The relative position information acquisition unit 12 acquires the information 32 on the relative positions between the subject 90 and each of the positioning members 1. Specifically, the relative position information acquisition unit 12 acquires the information 32 on the relative position measured by the three-dimensional coordinate measuring device 300. The information 32 on the relative positions is information on the relative positions between the subject 90 and each of the positioning members 1. In the present embodiment, the information 32 on the relative position includes position information 32a (see FIG. 11) on a reference position 3 set on the subject 90 and position information 32b (see FIG. 11) on each of the positioning members 1. The relative position information acquisition unit 12 acquires the information 32 on the relative position transmitted from the three-dimensional coordinate measuring device 300 via the network. When the information 32 on the relative position is stored in the storage unit 20, the relative position information acquisition unit 12 may read the information 32 on the relative position from the storage unit 20. The relative position information acquisition unit 12 outputs the acquired information 32 on the relative position to the second position information acquisition unit 15.

The first position information acquisition unit 14 acquires the position information on the positioning member 1 (see FIG. 7) in the CT data 30. Specifically, the first position information acquisition unit 14 acquires the first position information 33, which is the position information on a center point 2 (see FIG. 8) of the positioning member 1 in the CT data 30. The first position information acquisition unit 14 outputs the acquired first position information 33 to the registration unit 13.

The second position information acquisition unit 15 acquires the position information on the positioning member 1 in the design data 31 based on the design data 31 and the information 32 on the relative position. Specifically, the second position information acquisition unit 15 acquires the second position information 34, which is the position information on the center point 2 (see FIG. 8) of the positioning member 1 in the design data 31. The second position information acquisition unit 15 outputs the acquired second position information 34 to the registration unit 13.

The registration unit 13 performs the registration between the subject 90 in the CT data 30 and the subject 90 in the design data 31 based on the three-dimensional design data 31 of the subject 90 and the information 32 on the relative position. In the present embodiment, the registration unit 13 performs the registration between the subject 90 in the CT data 30 and the subject 90 in the design data 31 based on the first position information 33 and the second position information 34. The details of the configuration in which the registration unit 13 performs the registration between the subject 90 in the CT data 30 and the subject 90 in the design data 31 will be described later.

Three-Dimensional Shape Registration Method

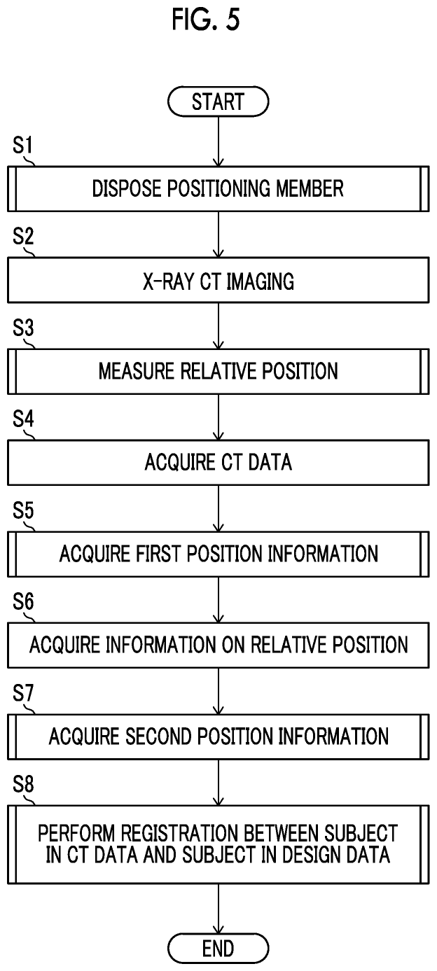

Next, with reference to FIG. 5, a three-dimensional shape registration method of the present embodiment will be described. The three-dimensional shape registration method of the present embodiment is a method of performing the registration between the subject 90 in the CT data 30 and the subject 90 in the design data 31. The three-dimensional shape registration method can be executed by the three-dimensional shape data processing device 100 (processor 10).

The three-dimensional shape registration method of the present embodiment includes at least the following steps.

A step (1) of acquiring the three-dimensional CT data 30 of the subject 90 and the positioning members, which are acquired by performing the X-ray CT imaging on at least three positioning members 1 together with the subject 90.

A step (2) of measuring the relative positions between the subject 90 and each of the positioning members 1.

A step (3) of performing the registration between the subject 90 in the CT data 30 and the subject 90 in the design data 31 based on the CT data 30, the three-dimensional design data 31 of the subject 90, and the information 32 on the relative position.

The step (1) of acquiring the CT data 30 is executed by the data acquisition unit 11. The step (1) of acquiring the CT data 30 is executed after the X-ray CT imaging by the X-ray CT imaging device 200 is performed. The step (2) of measuring the relative positions is executed by the three-dimensional coordinate measuring device 300. The step (3) of performing the registration between the subject 90 in the CT data 30 and the subject 90 in the design data 31 is executed by the registration unit 13. The three-dimensional shape registration method of the present embodiment further includes the processing of acquiring the first position information 33 by the first position information acquisition unit 14 and the processing of acquiring the second position information 34 by the second position information acquisition unit 15.

The three-dimensional shape registration method of the present embodiment further includes a step of disposing the positioning member 1 with respect to the subject 90 and a step of fixing the positioning member 1.

Next, the flow of processing by the three-dimensional shape data processing device 100 will be described in detail with reference to FIGS. 5 to 17.

Disposition of Positioning Member

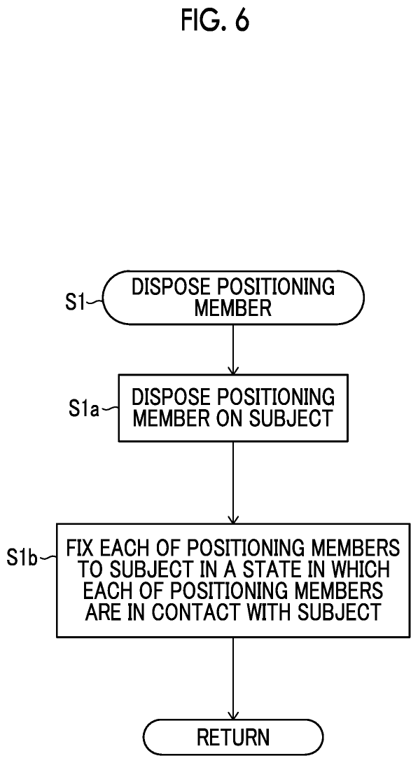

In step S1, the positioning member 1 is disposed with respect to the subject 90. With reference to FIGS. 6 to 9, the details of the disposition when the positioning member 1 is disposed on the subject 90 will be described.

In step S1a of FIG. 6, at least three positioning members 1 are disposed on the subject 90. In the present embodiment, the three positioning members 1 of the positioning member 1a to the positioning member 1c are disposed on the subject 90.

In step S1b, each of the positioning members 1 is fixed to the subject 90. In the present embodiment, each of the positioning members 1 is fixed to the subject 90 in a state of being in contact with the subject 90. As a result, the relative position of each of the positioning members 1 does not change until at least both the X-ray CT imaging and measurement of the relative position are completed. The method of fixing the positioning member 1 to the subject 90 includes fixing with an adhesive, screwing, or the like, but any method can be used as long as the positioning member 1 can be fixed to the subject 90.

As illustrated in FIG. 7, at least two positioning members 1 are disposed on different surfaces of the subject 90. In the example illustrated in FIG. 7, the positioning member 1a is disposed on a second surface 91c of the subject 90, and the positioning member 1c is disposed on a first surface 91a of the subject 90. Further, in the example illustrated in FIG. 7, the positioning member 1b is provided on a rectangular parallelepiped 90b in contact with the second surface 91c.

Further, as illustrated in FIG. 8, each of the positioning members 1 is disposed at a position where a plane 50 is formed by a straight line 4 (straight line 4a, straight line 4b, straight line 4c) when respective center positions of the positioning members 1 are connected by the straight line 4 (straight line 4a, straight line 4b, straight line 4c). The straight line 4a is a straight line connecting a center point 2a of the positioning member 1a and a center point 2b of the positioning member 1b. Further, the straight line 4b is a straight line connecting a center point 2b of the positioning member 1b and a center point 2c of the positioning member 1c. The straight line 4c is a straight line connecting a center point 2c of the positioning member 1c and a center point 2a of the positioning member 1a.

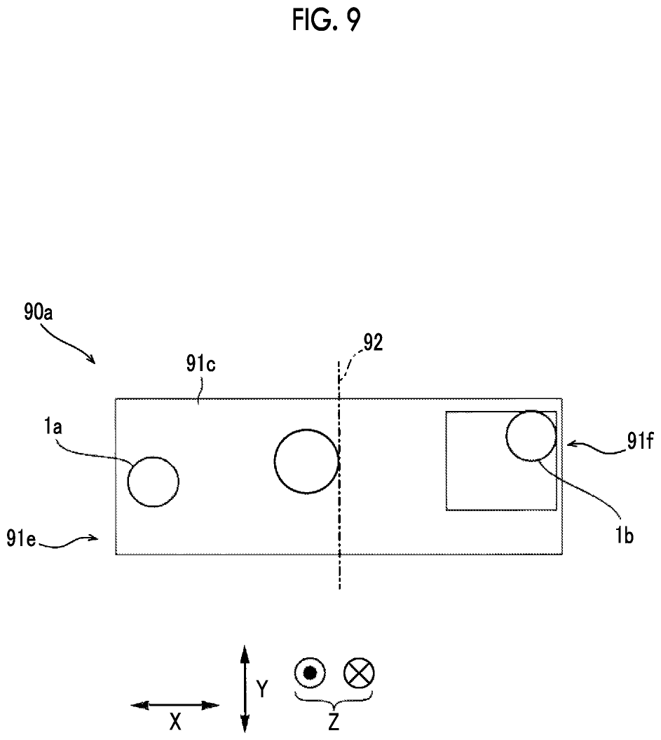

Further, as illustrated in FIG. 9, at least one of the positioning members 1 is disposed at a position closer to one end portion 91e of the subject 90 between the one end portion 91e in the longitudinal direction and a center 92 of the subject 90 in the longitudinal direction, and at least another of the positioning members 1 is disposed at a position closer to the other end portion 91f of the subject 90 between the other end portion 91f in the longitudinal direction and the center 92 in the longitudinal direction. In FIG. 9, for convenience, the center 92 of the subject 90 in the longitudinal direction is illustrated using an alternate long and short dash line.

X-Ray CT Imaging

In step S2 of FIG. 5, the X-ray CT imaging device 200 performs the X-ray CT imaging for the subject 90. As a result, the three-dimensional CT data 30 of the subject 90 is generated. The generated CT data 30 is transmitted to the three-dimensional shape data processing device 100.

Measurement of Relative Position

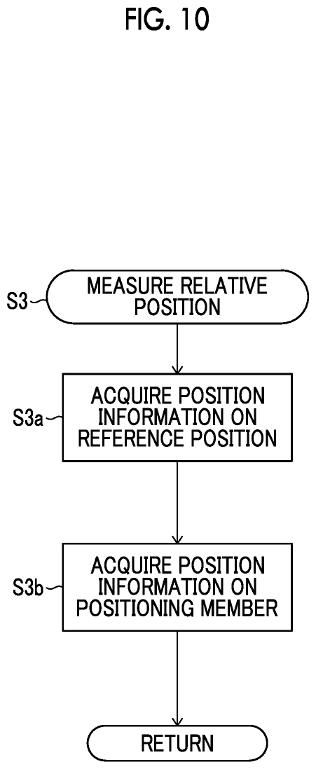

In step S3 of FIG. 5, the three-dimensional coordinate measuring device 300 measures the relative positions of the subject 90 and each of the positioning members 1 disposed on the subject 90. The details of the measurement of the relative position by the three-dimensional coordinate measuring device 300 will be described with reference to FIGS. 10 and 11.

As illustrated in FIG. 10, processing of acquiring the information 32 on the relative position by the three-dimensional coordinate measuring device 300 includes a step S3a of acquiring position information 32a on the reference position 3 and a step S3b of acquiring position information 32b on the positioning member 1.

In step S3a, the three-dimensional coordinate measuring device 300 acquires the position information 32a on the reference position 3.

In step S3b, the three-dimensional coordinate measuring device 300 acquires the position information 32b on each of the positioning members 1 by making the probe 310 contact with each of the positioning members 1.

As illustrated in FIG. 11, in the present embodiment, the three-dimensional coordinate measuring device 300 performs the measurement of the relative position by making the probe 310 contact with the subject 90 and each of the positioning members 1. The reference position 3 is a position of the center of the circular hole 91b provided on a surface (a first surface 91a) of the subject 90, which is positioned on the same plane as the surface (the first surface 91a). In the present embodiment, the three-dimensional coordinate measuring device 300 acquires the position information on the first surface 91a by making the probe 310 contact with a predetermined position of the first surface 91a of the subject 90. The three-dimensional coordinate measuring device 300 acquires the position information on the first surface 91a by, for example, contacting the probe 310 with each of contact positions 311 set at six locations of the first surface 91a. Similarly, the position information on the second surface 92c is also acquired for an upper surface (a second surface 91c) of the subject 90.

Further, the three-dimensional coordinate measuring device 300 acquires the position information on the circular hole 91b by making the probe 310 contact with an inner peripheral surface of the circular hole 91b. Specifically, the three-dimensional coordinate measuring device 300 acquires the position information on the circular hole 91b by making the probe 310 contact with each of contact positions 312 set on the inner peripheral surface of the circular hole 91b. The three-dimensional coordinate measuring device 300 acquires the position information 32a on the reference position 3 based on the position information on the first surface 91a, the position information on the second surface 91c, and the position information on the circular hole 91b. The three-dimensional coordinate measuring device 300 acquires coordinate values of (X0, Y0, Z0) and directions as the position information 32a on the reference position 3. In the present embodiment, the information 32 on the relative position is position information in a first coordinate system defined based on the position information 32a on the reference position 3.

Specifically, the three-dimensional coordinate measuring device 300 acquires the position information on the center point 2 (see FIG. 8) of the positioning member 1. In the present embodiment, the three-dimensional coordinate measuring device 300 acquires the position information on the center point 2a of the positioning member 1a, the position information on the position of the center point 2b of the positioning member 1b, and the position information on the center point 2c of the positioning member 1c. Specifically, the three-dimensional coordinate measuring device 300 acquires coordinate values (X1, Y1, Z1) of the center point 2a of the positioning member 1a as the position information 32b on the positioning member 1a. Further, the three-dimensional coordinate measuring device 300 acquires coordinate values (X2, Y2, Z2) of the center point 2b of the positioning member 1b as the position information 32b on the positioning member 1b. Further, the three-dimensional coordinate measuring device 300 acquires coordinate values (X3, Y3, Z3) of the center point 2c of the positioning member 1c as the position information 32b on the positioning member 1c.

The position information 32a on the reference position 3 and the position information 32b on the positioning member 1 acquired by the three-dimensional coordinate measuring device 300 are transmitted to the three-dimensional shape data processing device 100. The position information 32a on the reference position 3 and the position information 32b on the positioning member 1 may be stored in the storage unit 20 included in the three-dimensional shape data processing device 100.

Acquisition of CT Data

In step S4 of FIG. 5, the data acquisition unit 11 (see FIG. 3) performs the processing of acquiring the CT data 30 (step (1) above). The data acquisition unit 11 acquires the CT data 30 by receiving the CT data 30 transmitted from the X-ray CT imaging device 200 via the network or the like. Further, the data acquisition unit 11 stores the acquired CT data 30 in the storage unit 20. When the CT data 30 is stored in the storage unit 20 in advance, the processing of step S4 is omitted.

Acquisition of First Position Information

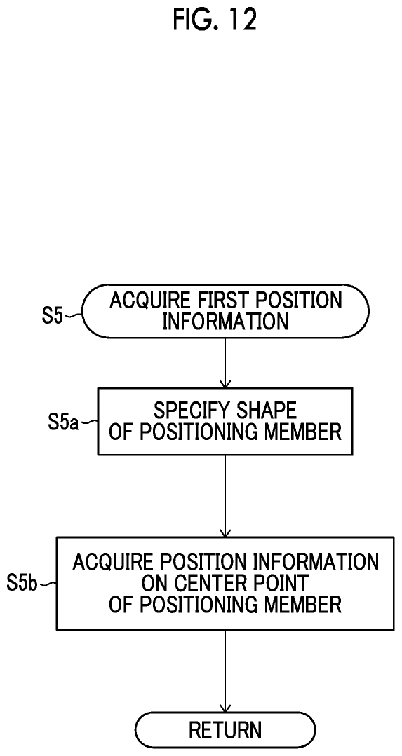

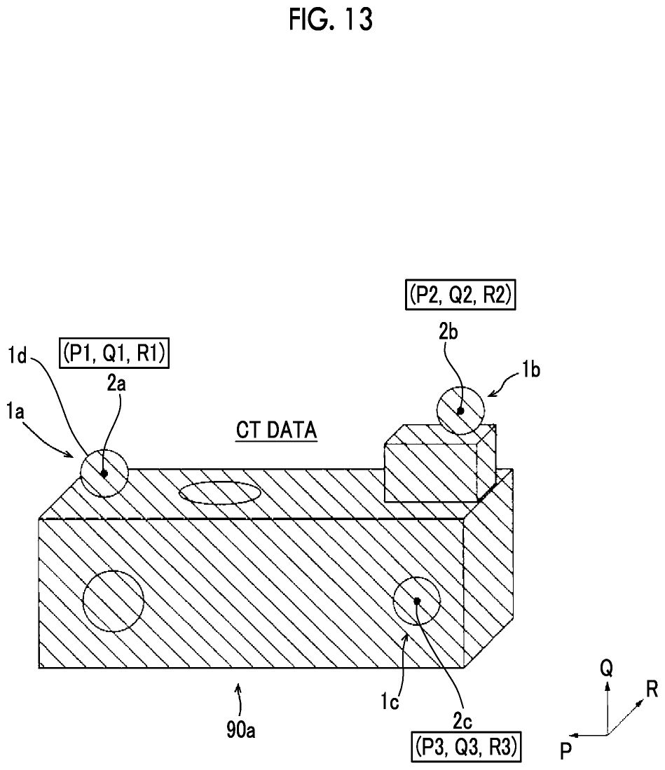

Thereafter, in step S5, the first position information acquisition unit 14 executes the processing of acquiring the first position information 33. The details of the processing of acquiring the first position information 33 will be described with reference to FIGS. 12 and 13.

As illustrated in FIG. 12, the step S5 of acquiring the first position information 33 includes step S5a of acquiring the shape of the positioning member 1 from the CT data 30 and step S5b of acquiring the position information on the center point 2 of the positioning member 1 in the CT data 30. The first position information 33 is the position information on the center point 2 of each of the positioning members 1 in the CT data 30.

In step S5a, the first position information acquisition unit 14 acquires the shape of the positioning member 1 in the CT data 30. In the present embodiment, the first position information acquisition unit 14 specifies the shape of the positioning member 1. The method by which the first position information acquisition unit 14 specifies the shape of the positioning member 1 is not limited. The CT data 30 is data indicating the shape of the three-dimensional subject 90 in a second coordinate system defined based on the P-axis, the Q-axis, and the R-axis.

In step S5b, the first position information acquisition unit 14 acquires the position information on the positioning member 1 in the second coordinate system. The first position information acquisition unit 14 acquires the first position information 33, which is the position information on the positioning member 1 in the CT data 30, based on the isotropic shape of the positioning member 1 in the CT data 30. More specifically, the first position information acquisition unit 14 acquires the first position information 33 based on position information on a surface 1d of the positioning member 1 having a spherical shape in the CT data 30.

The first position information acquisition unit 14 acquires a point positioned equidistant from each point on the surface 1d of the positioning member 1 whose position is specified in step S5a, as the center point 2 of the positioning member 1. The position information on each point on the surface 1d of the positioning member 1 in the CT data 30 can be acquired from the CT data 30 as coordinate values of the second coordinate system. Further, the positioning member 1 has a spherical shape which is an isotropic shape. Therefore, the first position information acquisition unit 14 can accurately acquire the position information (the first position information 33) on the center point 2 of the positioning member 1 in the second coordinate system. Further, the first position information acquisition unit 14 may acquire the position information on the first position information 33 on the positioning member 1 by using another known method.

In the present embodiment, as illustrated in FIG. 13, the first position information acquisition unit 14 acquires position coordinates (P1, Q1, R1) of the center point 2a in the second coordinate system as the first position information 33 on the positioning member 1a. Further, the first position information acquisition unit 14 acquires position coordinates (P2, Q2, R2) of the center point 2b in the second coordinate system as the first position information 33 on the positioning member 1b. Further, the first position information acquisition unit 14 acquires position coordinates (P3, Q3, R3) of the center point 2c in the second coordinate system as the first position information 33 on the positioning member 1c.

The first position information acquisition unit 14 outputs the acquired first position information 33 to the storage unit 20. That is, the first position information 33 is stored in the storage unit 20.

Acquisition of Information on Relative Position

In step S6 of FIG. 5, the relative position information acquisition unit 12 acquires the information 32 on the relative position. Specifically, the relative position information acquisition unit 12 receives the information 32 on the relative position transmitted from the three-dimensional coordinate measuring device 300. The relative position information acquisition unit 12 outputs the received information 32 on the relative position to the storage unit 20. That is, the information 32 on the relative position is stored in the storage unit 20.

Acquisition of Second Position Information

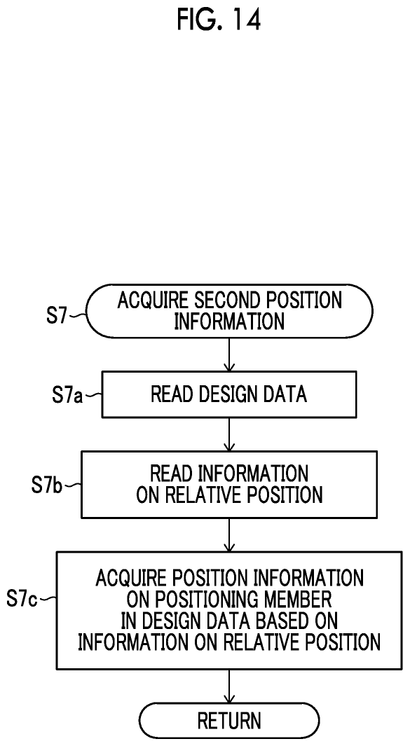

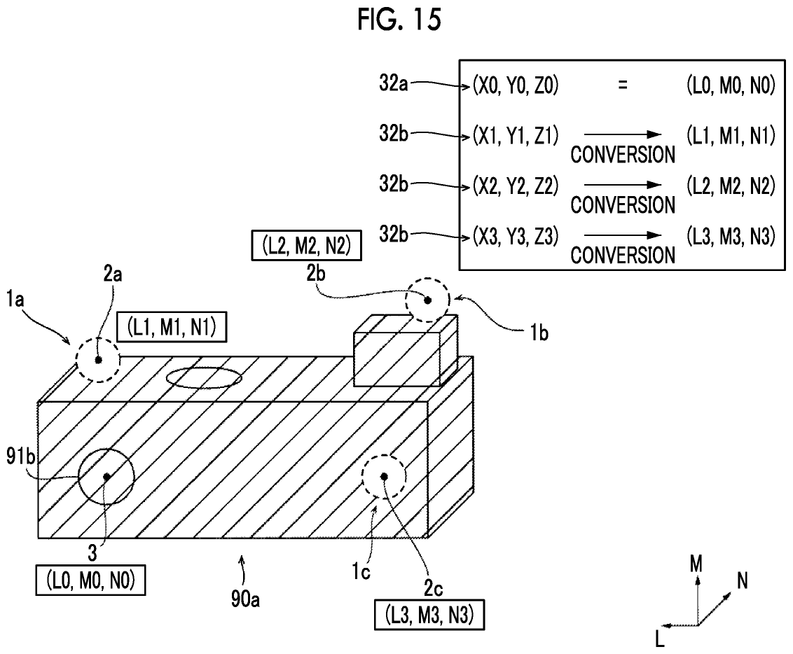

Next, in step S7, the second position information acquisition unit 15 executes the processing of acquiring the second position information 34. The details of the processing of acquiring the second position information 34 will be described with reference to FIGS. 14 and 15. The second position information 34 is the position information on the center point 2 (see FIG. 8) of each of the positioning members 1 in the design data 31.

As illustrated in FIG. 14, the step S7 of acquiring the second position information 34 includes step S7a of reading the design data 31, step S7b of reading the information 32 on the relative position, and step S7c of acquiring the position information on the positioning member 1 in the design data 31 based on the design data 31 and the information 32 on the relative position.

In step S7a, the second position information acquisition unit 15 reads the design data 31 from the storage unit 20.

In step S7b, the second position information acquisition unit 15 reads the information 32 on the relative position from the storage unit 20.

In step S7c, the second position information acquisition unit 15 acquires the position information on each of the positioning members 1 based on the information 32 on the relative position and the design data 31.

In the present embodiment, as illustrated in FIG. 15, the second position information acquisition unit 15 acquires the second position information 34, which is the position information on the positioning member 1 in the design data 31, based on a measured value of the position information 32a on the reference position 3 and the position information 32a on the reference position 3 in the design data 31. The design data 31 is data indicating the shape of the three-dimensional subject 90 in a third coordinate system defined based on the L-axis, the M-axis, and the N-axis. Further, in the example illustrated in FIG. 15, for convenience, the positioning members 1a to 1c are illustrated using broken lines, but the design data 31 does not include the positioning members 1a to 1c.

The design data 31 does not include the position information on the positioning member 1. On the other hand, the design data 31 includes the position information on the reference position 3. Therefore, the second position information acquisition unit 15 can acquire position coordinates (L0, M0, N0) of the reference position 3 in the design data 31 (the third coordinate system) based on the design data 31.

The second position information acquisition unit 15 acquires the position information on the positioning member 1 in the design data 31 by performing the registration between the position coordinates (X0, Y0, Z0) of the reference position 3 in the first coordinate system and the position coordinates (L0, M0, N0) of the reference position 3 in the third coordinate system. Specifically, after the registration is performed between the position coordinates (X0, Y0, Z0) of the reference position 3 in the first coordinate system and the position coordinates (L0, M0, N0) of the reference position 3 in the third coordinate system, the second position information acquisition unit 15 acquires the position coordinates of each positioning member 1 in the third coordinate system based on a relationship between the position coordinates (X0, Y0, Z0) of the first coordinate system, which are the measured values of the position information 32a on the reference position 3, and the position coordinates (X1, Y1, Z1), (X2, Y2, Z2), and (X3, Y3, Z3) of each of the positioning members 1. That is, the second position information acquisition unit 15 acquires the position coordinates of each positioning member 1 in the design data 31 by converting the position coordinates (X1, Y1, Z1), (X2, Y2, Z2), and (X3, Y3, Z3) of each of the positioning members 1 into the position coordinates of the third coordinate system.

Specifically, the second position information acquisition unit 15 acquires a distance from the reference position 3 in the first coordinate system to the positioning member 1a in each axial direction by using the position coordinates (X0, Y0, Z0) of the reference position 3 in the first coordinate system and the position coordinates (X1, Y1, Z1) of the positioning member 1a. That is, the second position information acquisition unit 15 acquires a distance from the reference position 3 to the positioning member 1a in the X-axis direction by subtracting the X coordinate (X0) of the reference position 3 from the X coordinate (X1) of the positioning member 1a. Similarly, the second position information acquisition unit 15 acquires a distance in the Y-axis direction and a distance in the Z-axis direction from the reference position 3 to the positioning member 1a by performing the subtraction of the Y coordinate (Y1−Y0) and the subtraction of the Z coordinate (Z1−Z0).

The second position information acquisition unit 15 converts the position coordinates of the positioning member 1a to (L1, M1, N1) by adding a distance from the reference position 3 in the first coordinate system with respect to the position coordinates (L0, M0, N0) of the reference position 3 in the third coordinate system in each axial direction of the positioning member 1a. That is, the second position information acquisition unit 15 acquires the position coordinates (L1, M1, N1) of the positioning member 1a in the third coordinate system by adding (X1−X0, Y1−Y0, Z1−Z0) with respect to the position coordinates (L0, M0, N0) of the reference position 3 in the third coordinate system.

By using the same method, the second position information acquisition unit 15 acquires the position coordinates (X2, Y2, Z2) of the positioning member 1b in the first coordinate system and the position coordinates (L2, M2, N2) of the positioning member 1b in the third coordinate system. Further, by using the same method, the second position information acquisition unit 15 acquires the position coordinates (X3, Y3, Z3) of the positioning member 1b in the first coordinate system and the position coordinates (L3, M3, N3) of the positioning member 1c in the third coordinate system.

As a result, the second position information acquisition unit 15 can acquire the second position information 34, which is the position coordinates of each of the positioning members 1 in the third coordinate system. The second position information acquisition unit 15 outputs the acquired second position information 34 to the storage unit 20. That is, the second position information 34 is stored in the storage unit 20.

Registration of Subject

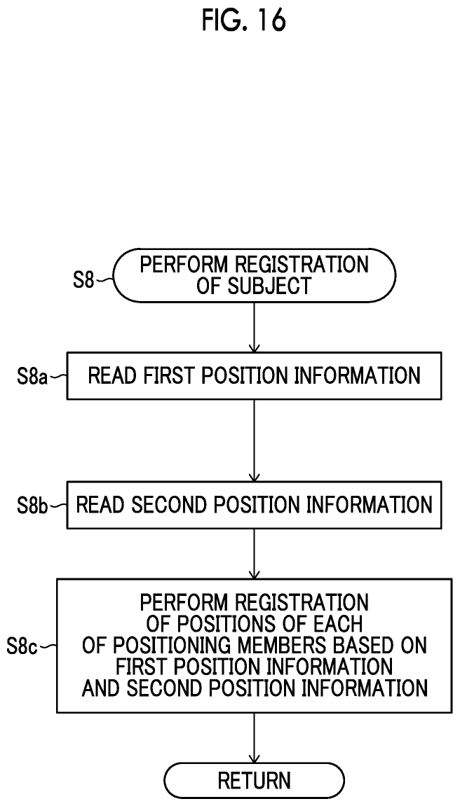

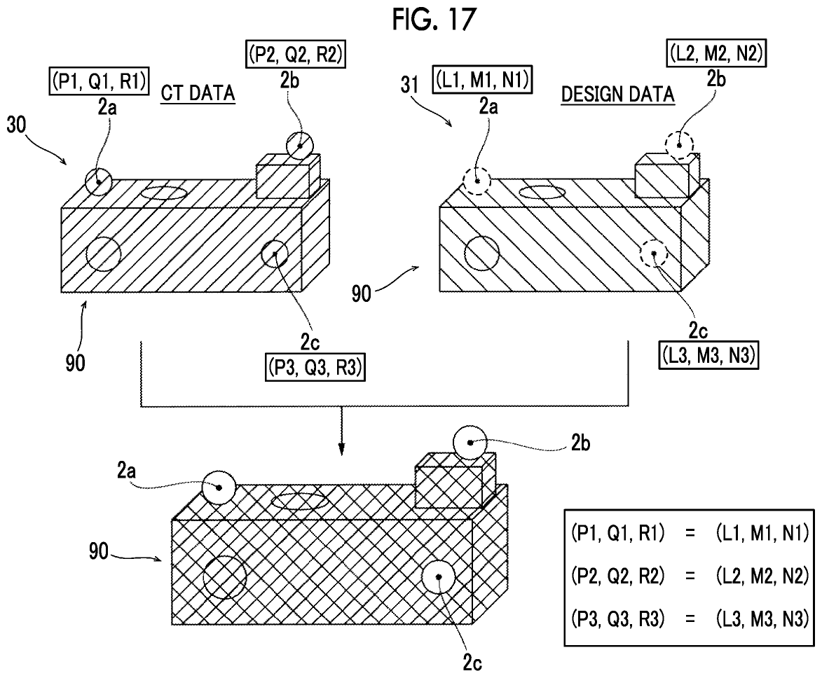

In step S8 of FIG. 5, the registration unit 13 executes the registration processing (step (3)) between the subject 90 in the CT data 30 and the subject 90 in the design data 31. The details of the processing in which the registration unit 13 performs the registration between the subject 90 in the CT data 30 and the subject 90 in the design data 31 will be described with reference to FIGS. 16 and 17.

As illustrated in FIG. 16, step S8 of performing the registration between the subject 90 in the CT data 30 and the subject 90 in the design data 31 includes step S8a of reading the first position information 33, step S8b of reading the second position information 34, and step S8c of performing the registration between the subject 90 in the CT data 30 and the subject 90 in the design data 31 based on the first position information 33 and the second position information 34.

In step S8a, the first position information acquisition unit 14 reads the first position information 33 from the storage unit 20.

In step S8b, the first position information acquisition unit 14 reads the second position information 34 from the storage unit 20. Either the processing of step S8a or the processing of step S8b may be executed first.

In step S8c, the registration unit 13 performs the registration between the subject 90 in the CT data 30 and the subject 90 in the design data 31 based on the first position information 33 and the second position information 34.

Specifically, as illustrated in FIG. 17, the registration unit 13 performs the registration between the subject 90 in the CT data 30 and the subject 90 in the design data 31 by performing registration between a position in each of the first position information 33 and a position in each of the second position information 34 corresponding to the first position information 33.

That is, the registration unit 13 performs the registration between the position coordinates (P1, Q1, R1) of the center point 2a in the CT data 30 and the position coordinates (L1, M1, N1) of the center point 2a in the design data 31. Further, the registration unit 13 performs the registration between the position coordinates (P2, Q2, R2) of the center point 2b in the CT data 30 and the position coordinates (L2, M2, N2) of the center point 2b in the design data 31. Further, the registration unit 13 performs the registration between the position coordinates (P3, Q3, R3) of the center point 2c in the CT data 30 and the position coordinates (L3, M3, N3) of the center point 2c in the design data 31. As a result, the registration unit 13 performs the registration between the position and posture of the subject 90 in the CT data 30 and the subject 90 in the design data 31.

That is, in the present embodiment, the registration unit 13 acquires a conversion matrix by performing the registration for each of the center points 2, and performs the registration between the subject 90 in the CT data 30 and the subject 90 in the design data 31 by converting the coordinates of each of the points of the subject 90 in the CT data 30 based on the acquired conversion matrix. The registration unit 13 may be configured to perform the registration between the subject 90 in the CT data 30 with the subject 90 in the design data 31 by converting each of the points of the design data 31 based on the acquired conversion matrix.

As described above, the three-dimensional shape registration method implemented by the three-dimensional shape data processing device 100 of the present embodiment is completed.

Effects of the Present Embodiment

In the present embodiment, the following effects can be obtained.

In the present embodiment, as described above, the three-dimensional shape registration method includes the step of acquiring the three-dimensional CT data 30 of the subject 90 and at least three positioning members 1, which are acquired by performing the X-ray CT imaging on the positioning members 1 together with the subject 90, the step of measuring the relative positions between the subject 90 and each of the positioning members 1, and the step of performing the registration between the subject 90 in the CT data 30 and the subject 90 in the design data 31 based on the CT data 30, the three-dimensional design data 31 of the subject 90, and the information 32 on the relative positions.

Thereby, the position information on the positioning member 1 in the design data 31 can be acquired based on the design data 31 and the information 32 on the relative position. Therefore, when the registration between the subject 90 in the CT data 30 and the subject 90 in the design data 31 is performed, it is possible to perform the registration for the subject 90 of each data by performing the registration between the position of the positioning member 1 in the CT data 30 and the position of the positioning member 1 in the design data 31. Therefore, for example, by using the positioning member 1 having a shape capable of accurately acquiring the shape in the CT data 30, the registration between the subject 90 in the CT data 30 and the subject 90 in the design data 31 can be performed without depending on the shape of the subject 90. As a result, the registration between the position of the subject 90 in the CT data 30 and the position of the subject 90 in the design data 31 can be accurately performed without depending on the shape of the subject 90.

Further, in the present embodiment, as described above, the three-dimensional shape data processing device 100 includes the data acquisition unit 11 that acquires the three-dimensional CT data 30 of the subject 90 and at least three positioning members 1, which are acquired by performing the X-ray CT imaging on the positioning members 1 together with the subject 90, the relative position information acquisition unit 12 that acquires the information 32 on relative positions between the subject 90 and each of the positioning members 1, and the registration unit 13 that performs registration between the subject 90 in the CT data 30 and the subject 90 in design data 31 based on the CT data 30, the three-dimensional design data 31 of the subject 90, and the information 32 on the relative positions.

In this way, similar to the above three-dimensional shape registration method, it is possible to provide the three-dimensional shape data processing device 100 capable of accurately performing the registration between the subject 90 in the CT data 30 and the subject 90 in the design data 31 without depending on the shape of the subject 90.

Further, in the above embodiment, the following further effects can be obtained by configuring the method as follows.

That is, in the present embodiment, as described above, the positioning member 1 has an isotropic shape, and a step of acquiring the first position information 33, which is the position information on the positioning member 1 in the CT data 30, based on the isotropic shape of the positioning member 1 in the CT data 30 is further included. In a case where the CT data 30 is acquired, when the positioning member 1 has an isotropic shape, a difference in path lengths of the X-rays transmitted through the positioning member 1 for each imaging angle, when imaging while rotating the positioning member 1, becomes small. When the difference in the path lengths of the X-rays for each imaging angle is small, a difference in detection intensities of the X-rays caused by the path lengths of the X-rays for each imaging angle, becomes small. That is, it is possible to reduce a decrease in the accurate acquisition of the shape of the positioning member 1 due to the difference in the detection intensities of X-rays caused by the difference in the path lengths. Therefore, by configuring the method as described above, since the shape of the positioning member 1 is isotropic, the shape of the positioning member 1 in the CT data 30 can be accurately acquired. As a result, since the first position information 33 acquired based on the shape of the positioning member 1 can be accurately acquired, it is possible to improve the accuracy of performing the registration between the subject 90 in the CT data 30 and the subject 90 in the design data 31.

Further, in the present embodiment, as described above, the positioning member 1 has a spherical shape as an isotropic shape, and in the step of acquiring the first position information 33, the first position information 33 is acquired based on the position information of the surface 1d of the positioning member 1 having a spherical shape in the CT data 30. When the CT data 30 of the positioning member 1 having a spherical shape is acquired, there is no difference in the path lengths of the X-rays depending on the imaging angle. Therefore, in the CT data 30, the shape of the positioning member 1 can be acquired more accurately. Therefore, as described above, the accuracy of the first position information 33 can be further improved by acquiring the first position information 33 based on the position information on the surface 1d of the positioning member 1 having a spherical shape. As a result, the accuracy of the registration between the subject 90 in the CT data 30 and the subject 90 in the design data 31 can be further improved.

Further, in the present embodiment, as described above, the information 32 on the relative position includes the position information 32a on the reference position 3 set for the subject 90 and the position information 32b on each of the positioning members 1, the step of acquiring the second position information 34 that is the position information on the positioning member 1 in the design data 31, based on the measured value of the position information 32a on the reference position 3 and the position information 32a on the reference position 3 in the design data 31 is further included, and in the step of performing registration, the registration is performed between the subject 90 in the CT data 30 and the subject 90 in the design data 31 based on the first position information 33 and the second position information 34. The CT data 30 and the design data 31 are data having different coordinate systems from each other. However, the relative positions of each of the positioning members 1 in the first position information 33 and the relative positions of each of the positioning members 1 in the second position information 34 are equal to each other. Therefore, it is possible to perform the registration between the subject 90 in the CT data 30 and the subject 90 in the design data 31, which are data having different coordinate systems from each other, based on the first position information 33 and the second position information 34. Therefore, with the above configuration, by acquiring the first position information 33 and the second position information 34, it is possible to easily perform the registration between the subject 90 in the CT data 30 and the subject 90 in the design data 31.

Further, in the present embodiment, as described above, in the step of performing the registration, the registration between the subject 90 in the CT data 30 and the subject 90 in the design data 31 is performed by performing registration between a position in each of the first position information 33 and a position in each of the second position information 34 corresponding to the first position information 33. As a result, since at least three positioning members 1 are disposed, by using each of the first position information 33 and the second position information 34 corresponding to the first position information 33, it is possible to perform not only the registration of the positions between the subject 90 in the CT data 30 and the subject 90 in the design data 31, but also the registration of the postures of the subject 90 in the CT data 30 and the subject 90 in the design data 31.

Further, in the present embodiment, as described above, the first position information 33 is the position information on the center point 2 of each of the positioning members 1 in the CT data 30, and the second position information 34 is the position information on the center point 2 of each of the positioning members 1 in the design data 31. As a result, unlike the configuration in which the position information on any points from the positioning member 1 is acquired as the first position information 33 and the second position information 34, the position information on the center point 2 of the positioning member 1 that is a unique point is acquired, so that the position information on each of the positioning members 1 can be easily and accurately acquired.

Further, in the present embodiment, as described above, in the step of measuring the relative position, the relative position is measured by making the probe 310 contact with the subject 90 and each of the positioning members 1. As a result, it is possible to accurately acquire the information 32 on the relative positions between the subject 90 and each of the positioning members 1 with the contact type three-dimensional coordinate measuring device 300 that acquires the position information on the subject 90 by making the probe 310 contact with the subject 90 and each of the positioning members 1.

Further, in the present embodiment, as described above, the reference position 3 is a position of the center of the circular hole 91b provided on a surface (a first surface 91a) of the subject 90, which is positioned on the same plane as the surface (the first surface 91a). As a result, the position can be acquired accurately by the three-dimensional coordinate measuring device 300, for example, since the center of the circular hole 91b, which is positioned on the same plane as the surface (the first surface 91a) of the subject 90, is acquired as the reference position 3, the position of the positioning member 1 can be accurately acquired in the design data 31. As a result, the accuracy of the registration between the subject 90 in the CT data 30 and the subject 90 in the design data 31 can be improved.

Further, in the present embodiment, as described above, each of the positioning members 1 is disposed at a position where a plane 50 is formed by a straight line 4 (straight line 4a, straight line 4b, straight line 4c) when respective center positions of the positioning members 1 are connected by the straight line 4 (straight line 4a, straight line 4b, straight line 4c). As a result, unlike the disposition in which each of the positioning members 1 is disposed in a straight line, the registration can be performed not only on the position of the subject 90 but also on the posture when performing the registration of the positions between the subject 90 in the CT data 30 and the subject 90 in the design data 31, based on the positioning members 1. As a result, it is possible to easily perform the registration of the positions and postures between the subject 90 in the CT data 30 and the subject 90 in the design data 31.

Further, in the present embodiment, as described above, the three-dimensional shape registration method further includes a step of disposing at least one of the positioning members 1 at a position closer to one end portion 91e of the subject 90 between the one end portion 91e in the longitudinal direction and a center 92 of the subject 90 in the longitudinal direction, and at least another of the positioning members 1 at a position closer to the other end portion 91f of the subject 90 between the other end portion 91f in the longitudinal direction and the center 92 in the longitudinal direction. Unlike the subject 90, the position information on the respective center points 2 of the positioning members 1 can be accurately acquired. Therefore, the plane 50 formed by connecting the respective center points 2 of the positioning members 1 with the straight line 4 can also be accurately acquired. That is, by performing the registration based on the position information on the accurately acquired center points 2, the registration of each point included in the plane 50 can be accurately performed. Therefore, by configuring as described above, the distance between at least two positioning members 1 can be increased as compared with the case where at least two of the positioning members 1 are disposed at a position closer to one end portion 91e or at a position closer to the other end portion 91f between the one end portion 91e of the subject 90 in the longitudinal direction and the center 92 of the subject 90 in the longitudinal direction. Therefore, the size (area) of the plane 50 formed by connecting the respective center positions (center points 2) of the positioning members 1 with the straight line 4 can be easily increased. As a result, the area of the plane 50, which can be accurately acquired, can be easily increased, so that the accuracy of the registration by using the positioning members 1 can be easily improved by the amount of the increased area.

Further, in the present embodiment, as described above, in the step of disposing the positioning member 1, at least two of the positioning members 1 are disposed on different surfaces of the subject 90. Thereby, the distance between at least two of the positioning members 1 can be increased as compared with the configuration in which at least two positioning members 1 are disposed on the same surface of the subject 90. Therefore, the size (area) of the plane 50 formed by connecting the respective center positions (center points 2) of the positioning members 1 with the straight line 4 can be increased more easily. As a result, the area of the plane 50, which can be accurately acquired, can be increased more easily, so that the accuracy of the registration by using the positioning members 1 can be improved more easily by the amount of the increased area.

Further, in the present embodiment, as described above, the positioning member 1 is made of a material having an X-ray transmittance which is the same or similar to the subject 90. When the X-ray transmittance of the positioning member 1 is larger than the X-ray transmittance of the subject 90, a pixel value of the positioning member 1 in the CT data 30 is larger than a pixel value of the subject 90. In this case, an artifact may occur due to the large pixel value of the positioning member 1 in the CT data 30. When the artifact occurs, it may be difficult to recognize the shape of the subject 90 in the CT data 30. Therefore, as described above, by using the positioning member 1 that is made of a material having an X-ray transmittance which is the same or similar to the subject 90, it is possible to reduce the occurrence of the artifacts in the CT data 30. As a result, it is possible to reduce the difficulty in recognizing the shape of the subject 90 in the CT data 30 due to the artifact.

Further, in the present embodiment, as described above, a step of fixing each of the positioning members 1 to the subject 90 in a state in which each of the positioning members 1 is in contact with the subject 90, is further included. As a result, since the positioning member 1 is fixed to the subject 90 in a state of being in contact with the subject 90, it is possible to reduce the change in the relative position of the positioning member 1 when acquiring the CT data 30 and the information 32 on the relative position.

### Modification Example

Note that the embodiment disclosed this time should be considered to be exemplary and not restrictive in all respects. The scope of the present invention is indicated by the scope of claims rather than the description of the above-described embodiment, and further includes all modifications (modification examples) within the meaning and scope equivalent to the scope of claims.

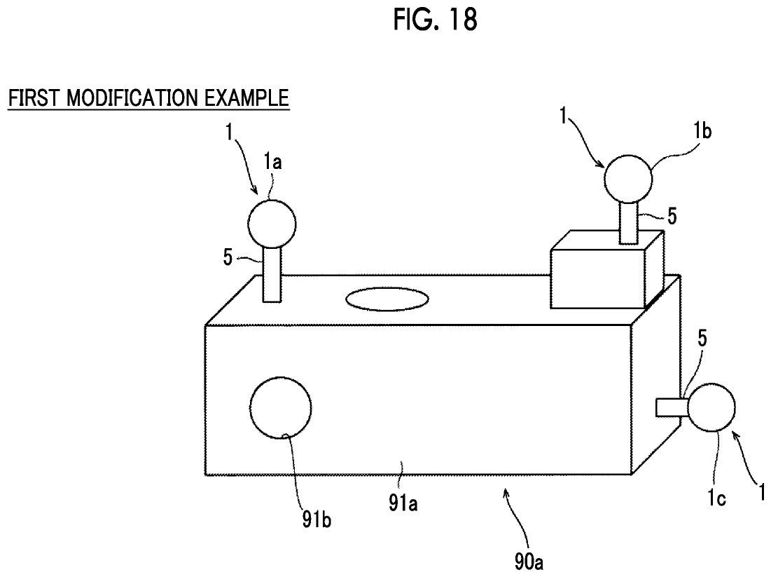

For example, in the above embodiment, an example of a configuration in which the positioning member 1 is fixed to the subject 90 in a state of being in contact with the subject 90, is shown, but the present invention is not limited to this. For example, as in a first modification example illustrated in FIG. 18, the positioning member 1 may be fixed to the subject 90 via a jig 5. Specifically, each of the positioning members 1 may be fixed to the subject 90 via the jig 5 for fixing. In this case, in the processing of step S1b of fixing the positioning member 1 to the subject 90 in the above embodiment, the jig 5 to which the positioning member 1 is fixed may be fixed to the subject 90. Thereby, for example, even when it is difficult to fix the positioning member 1 to the subject 90 in a state of being in contact with the subject 90, the positioning member 1 can be fixed to the subject 90 via the jig 5. As a result, the degree of freedom in selection of the positioning member 1 can be improved, so that the convenience of an operator can be improved. The jig 5 is preferably made of a material having high rigidity so that the relative position between the subject 90 and the positioning member 1 does not change when performing the X-ray CT imaging. The jig 5 is preferably made of, for example, a resin material or a metal material.

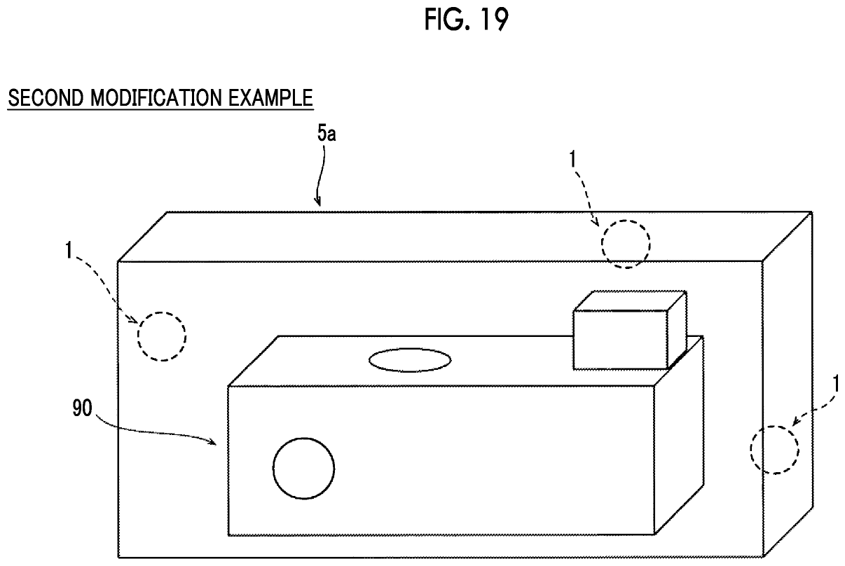

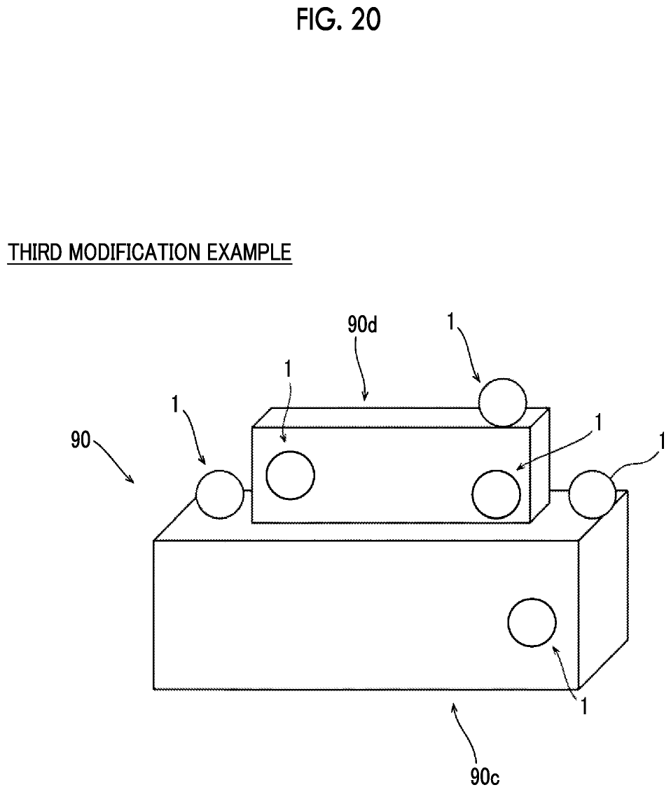

Further, for example, as illustrated in a second modification example of FIG. 19, at least three positioning members 1 are provided on the inner peripheral surface of the jig 5a having a box shape, and the positioning member 1 and the subject 90 may be configured to be fixed by fixing the subject 90 inside the jig 5a having a box shape. As illustrated in the second modification example, when the jig 5a has a box shape, it becomes difficult for the probe 310 of the three-dimensional coordinate measuring device 300 to be in contact with the positioning member 1. Therefore, when the jig 5a has a box shape, the acquisition of the information 32 on the relative position may be performed by using a non-contact type three-dimensional coordinate measuring device. Further, the positioning member 1 may be configured to be fixed to the subject 90 by using a jig (not illustrated) having a frame-like shape instead of a box shape. In this case, since the jig has a frame-like shape, the information 32 on the relative position can be acquired by using the contact type three-dimensional coordinate measuring device 300.

Further, in the above embodiment, an example of a configuration in which the registration unit 13 performs the registration of the subject 90 that is a single component, is shown, but the present invention is not limited to this. For example, as in a third modification example illustrated in FIG. 20, the registration unit 13 may be configured to perform the registration of the subject 90 in which a first component 90c and a second component 90d are combined. When the subject 90 is composed of a plurality of components of the first component 90c and the second component 90d as in the third modification example, in step S4 of acquiring the CT data 30, the CT data 30, which is acquired in a state in which at least three positioning members 1 are disposed for each of the components (the first component 90c, the second component 90d) may be acquired. As a result, since at least three positioning members 1 are provided for each of the first component 90c and the second component 90d, by performing the registration between the subject 90 in the CT data 30 and the subject 90 in the design data 31 with the positioning members 1, it is possible to verify not only the manufacturing accuracy of each of the first component 90c and the second component 90d, but also the combining accuracy.

Further, in the above embodiment, an example of a configuration in which the positioning member 1 has a spherical shape as an isotropic shape, is shown, but the present invention is not limited to this. For example, the positioning member 1 may have a cubic shape as an isotropic shape. Further, the positioning member 1 may have a shape formed by providing a concave spherical surface on a cube or a rectangular parallelepiped as an isotropic shape.

Further, in the above embodiment, an example of a configuration in which the positioning member 1 has an isotropic shape, is shown, but the present invention is not limited to this. For example, the positioning member 1 may not have an isotropic shape. However, when the positioning member 1 does not have an isotropic shape, since the difference in the path lengths through which the X-rays are transmitted increases depending on the imaging angle in the X-ray CT imaging, it becomes difficult to accurately acquire the shape of the positioning member 1. In this case, it becomes difficult to accurately obtain the position information (the first position information 33) of the positioning member 1 in the CT data 30. Therefore, the accuracy of the registration between the subject 90 in the CT data 30 and the subject 90 in the design data 31 is decreased. Therefore, it is preferable that the positioning member 1 has an isotropic shape.

Further, in the above embodiment, an example in which the first position information 33 is the center point 2 of the positioning member 1 in the CT data 30, and the second position information 34 is the center point 2 of the positioning member 1 in the design data 31, is shown, but the present invention is not limited to this. For example, the first position information 33 may be position information on a point other than the center point 2 of the positioning member 1 in the CT data 30. Further, the second position information 34 may be position information on a point other than the center point 2 of the positioning member 1 in the design data 31. However, when the first position information 33 is the position information on a point other than the center point 2 of the positioning member 1 in the CT data 30, and the second position information 34 is position information on a point other than the center point 2 of the positioning member 1 in the design data 31, the registration using the first position information 33 and the second position information 34 becomes complicated. Therefore, it is preferable that the first position information 33 is the center point 2 of the positioning member 1 in the CT data 30, and the second position information 34 is the center point 2 of the positioning member 1 in the design data 31.

Further, in the above embodiment, an example of using the contact type three-dimensional coordinate measuring device 300 when acquiring the information 32 on the relative position is shown, but the present invention is not limited to this. For example, the information 32 on the relative position may be acquired by using the non-contact type three-dimensional coordinate measuring device. As long as it is possible to acquire the information 32 on the relative position with high accuracy, the device and method of acquiring the information 32 on the relative position are not limited.

Further, in the above embodiment, an example in which the configuration of disposing at least one of the positioning members 1 at a position closer to one end portion 91e of the subject 90 between the one end portion 91e in the longitudinal direction and a center 92 of the subject 90 in the longitudinal direction, and at least another of the positioning members 1 at a position closer to the other end portion 91f of the subject 90 between the other end portion 91f in the longitudinal direction and the center 92 in the longitudinal direction, is shown, but the present invention is not limited to this. For example, the positioning member 1 may be disposed at a position close to the center 92 of the subject 90 in the longitudinal direction. However, when the positioning member 1 is disposed at a position close to the center 92 of the subject 90 in the longitudinal direction, the size (area) of the plane 50 becomes small. In this case, the accuracy of the registration between the subject 90 in the CT data 30 and the subject 90 in the design data 31 is decreased. Therefore, it is preferable that at least one of the positioning members 1 is disposed at a position closer to one end portion 91e of the subject 90 between the one end portion 91e in the longitudinal direction and a center 92 of the subject 90 in the longitudinal direction, and at least another of the positioning members 1 is disposed at a position closer to the other end portion 91f of the subject 90 between the other end portion 91f in the longitudinal direction and the center 92 in the longitudinal direction.

Further, in the above embodiment, an example of a configuration in which at least two of the positioning members 1 are disposed on different surfaces (the first surface 91a and the second surface 91c) of the subject 90, is shown, but the present invention is not limited to this. For example, at least two of the positioning members 1 may be disposed on the same surface of the subject 90. In this case, it is preferable to dispose at least two of the positioning members 1 at positions as far apart as possible so that the size (area) of the plane 50 does not become small.

Further, in the above embodiment, the positioning member 1 is made of a material having an X-ray transmittance which is the same or similar to the subject 90, but the present invention is not limited to this. For example, the positioning member 1 may be made of a material having an X-ray transmittance lower than an X-ray transmittance of the subject 90. However, when the X-ray transmittance of the positioning member 1 is lower than the X-ray transmittance of the subject 90, an artifact may occur in the vicinity of the positioning member 1 in the CT data 30. In this case, it may be difficult to recognize the shape of the subject 90 in the CT data 30. Therefore, it is preferable that the positioning member 1 is made of a material having an X-ray transmittance which is the same or similar to the subject 90.

Further, in the above embodiment, an example of a configuration in which the three-dimensional shape data processing device 100 is the so-called personal computer and is provided separately from the X-ray CT imaging device 200, is shown, but the present invention is not limited to this. For example, the control unit 230 of the X-ray CT imaging device 200 may be configured to execute the three-dimensional shape registration method in the above embodiment.

Further, in the above embodiment, an example in which all data processing (each processing as the data acquisition unit 11, the relative position information acquisition unit 12, the registration unit 13, the first position information acquisition unit 14, and the second position information acquisition unit 15) is executed by a single processor 10, is shown, but the present invention is not limited to this. The three-dimensional shape data processing device 100 may not perform all the processing of the three-dimensional shape registration method. That is, the processing of step S1 in the above embodiment may be performed by a person. Further, a part of step S2 of performing the X-ray CT imaging and a part of step S3 of measuring the relative position may include a step in which a person intervenes. Further, the processing of performing the registration between the subject 90 in the CT data 30 and the subject 90 in the design data 31 may be shared and executed by a plurality of processors. Each processing may be executed by a separate processor. The plurality of processors may be provided in different computers. That is, the three-dimensional shape data processing device 100 may be configured with a plurality of computers that perform data processing.

Aspect

It will be understood by those skilled in the art that the above-mentioned exemplary embodiments are specific examples of the following aspects.

Item 1

A three-dimensional shape registration method includes a step of acquiring three-dimensional CT data of a subject and at least three positioning members, which are acquired by performing X-ray CT imaging on the positioning members together with the subject, a step of measuring relative positions between the subject and each of the positioning members, and a step of performing registration between the subject in the CT data and the subject in three-dimensional design data of the subject based on the CT data, the design data, and information on the relative positions.

Item 2

The three-dimensional shape registration method according to Item 1, in which the positioning member may have an isotropic shape, and the three-dimensional shape registration method may further include a step of acquiring first position information that is position information on the positioning member in the CT data, based on the isotropic shape of the positioning member in the CT data.

Item 3

The three-dimensional shape registration method according to Item 2, in which the positioning member may have a spherical shape as the isotropic shape, and in the step of acquiring first position information, the first position information may be acquired based on position information on a surface of the positioning member having the spherical shape in the CT data.

Item 4

The three-dimensional shape registration method according to Item 2 or 3, in which the information on the relative position may include position information on a reference position set for the subject and position information on each of the positioning members, the three-dimensional shape registration method may further include a step of acquiring second position information that is position information on the positioning member in the design data, based on a measured value of the position information on the reference position and position information on the reference position in the design data, and in the step of performing registration, registration may be performed between the subject in the CT data and the subject in the design data based on the first position information and the second position information.

Item 5

The three-dimensional shape registration method according to Item 4, in which in the step of performing registration, the registration may be performed between the subject in the CT data and the subject in the design data by performing registration between a position of each of the positioning members in the first position information and a position of each of the positioning members in the second position information corresponding to the first position information.

Item 6

The three-dimensional shape registration method according to Item 4 or 5, in which the first position information may be position information on a center point of each of the positioning members in the CT data, and the second position information may be position information on a center point of each of the positioning members in the design data.

Item 7

The three-dimensional shape registration method according to Item 6, in which in the step of measuring relative positions, measurement of the relative positions may be performed by making a probe contact with the subject and each of the positioning members.

Item 8

The three-dimensional shape registration method according to any one of Items 4 to 7, in which the reference position may be a position of a center of a circular hole provided on a surface of the subject, the center being positioned on the same plane as the surface.

Item 9

The three-dimensional shape registration method according to any one of Items 1 to 8, in which each of the positioning members may be disposed at a position such that when center positions of the respective positioning members are connected by a straight line, a plane is formed by the straight line.

Item 10

The three-dimensional shape registration method according to Item 9, may further include a step of disposing positioning members of disposing at least one of the positioning members at a position closer to one end portion of the subject in a longitudinal direction between the one end portion and a center of the subject in the longitudinal direction, and disposing at least another of the positioning members at a position closer to the other end portion of the subject in the longitudinal direction between the other end portion and the center of the subject in the longitudinal direction.

Item 11

The three-dimensional shape registration method according to Item 10, in which, in the step of disposing positioning members, at least two of the positioning members may be disposed on different surfaces of the subject.

Item 12

The three-dimensional shape registration method according to any one of Items 1 to 11, in which the positioning member may be made of a material having an X-ray transmittance which is the same or similar to the subject.

Item 13

The three-dimensional shape registration method according to any one of Items 1 to 12, may further include a step of fixing each of the positioning members to the subject in a state in which each of the positioning members is in contact with the subject.

Item 14

The three-dimensional shape registration method according to any one of Items 1 to 13, may further include a step of fixing each of the positioning members to the subject via a jig for fixing.

Item 15

The three-dimensional shape registration method according to any one of Items 1 to 14, in which in the step of acquiring three-dimensional CT data, when the subject is composed of a plurality of components, the CT data, which is acquired in a state in which at least three positioning members are disposed for each of the components, may be acquired.

Item 16

A three-dimensional shape data processing device includes a data acquisition unit that acquires three-dimensional CT data of a subject and at least three positioning members, which are acquired by performing X-ray CT imaging on the positioning members together with the subject, a relative position information acquisition unit that acquires information on relative positions between the subject and each of the positioning members, and a registration unit that performs registration between the subject in the CT data and the subject in three-dimensional design data of the subject based on the CT data, the design data, and the information on the relative positions.

What is claimed is:

1. A three-dimensional shape registration method comprising:
a step of acquiring three-dimensional CT data of a subject and at least three positioning members, which are acquired by performing X-ray CT imaging on the positioning members together with the subject;
a step of measuring relative positions between the subject and each of the positioning members; and
a step of performing registration between the subject in the CT data and the subject in three-dimensional design data of the subject based on the CT data, the design data, and information on the relative positions.

2. The three-dimensional shape registration method according to claim 1, wherein the positioning member has an isotropic shape, and
the three-dimensional shape registration method further comprises a step of acquiring first position information that is position information on the positioning member in the CT data, based on the isotropic shape of the positioning member in the CT data.

3. The three-dimensional shape registration method according to claim 2, wherein the positioning member has a spherical shape as the isotropic shape, and
in the step of acquiring first position information, the first position information is acquired based on position information on a surface of the positioning member having the spherical shape in the CT data.

4. The three-dimensional shape registration method according to claim 2, wherein the information on the relative position includes position information on a reference position set for the subject and position information on each of the positioning members,
the three-dimensional shape registration method further comprises a step of acquiring second position information that is position information on the positioning member in the design data, based on a measured value of the position information on the reference position and position information on the reference position in the design data, and
in the step of performing registration, registration is performed between the subject in the CT data and the subject in the design data based on the first position information and the second position information.

5. The three-dimensional shape registration method according to claim 4, wherein in the step of performing registration, the registration is performed between the subject in the CT data and the subject in the design data by performing registration between a position of each of the positioning members in the first position information and a position of each of the positioning members in the second position information corresponding to the first position information.

6. The three-dimensional shape registration method according to claim 4, wherein the first position information is position information on a center point of each of the positioning members in the CT data, and
the second position information is position information on a center point of each of the positioning members in the design data.

7. The three-dimensional shape registration method according to claim 6, wherein in the step of measuring relative positions, measurement of the relative positions is performed by making a probe contact with the subject and each of the positioning members.

8. The three-dimensional shape registration method according to claim 4, wherein the reference position is a position of a center of a circular hole provided on a surface of the subject, the center being positioned on the same plane as the surface.

9. The three-dimensional shape registration method according to claim 1, wherein each of the positioning members is disposed at a position such that when center positions of the respective positioning members are connected by a straight line, a plane is formed by the straight line.

10. The three-dimensional shape registration method according to claim 9, further comprising:
a step of disposing positioning members of disposing at least one of the positioning members at a position closer to one end portion of the subject in a longitudinal direction between the one end portion and a center of the subject in the longitudinal direction, and disposing at least another of the positioning members at a position closer to the other end portion of the subject in the longitudinal direction between the other end portion and the center of the subject in the longitudinal direction.

11. The three-dimensional shape registration method according to claim 10, wherein in the step of disposing positioning members, at least two of the positioning members are disposed on different surfaces of the subject.

12. The three-dimensional shape registration method according to claim 1, wherein the positioning member is made of a material having an X-ray transmittance which is the same or similar to the subject.

13. The three-dimensional shape registration method according to claim 1, further comprising:
a step of fixing each of the positioning members to the subject in a state in which each of the positioning members is in contact with the subject.

14. The three-dimensional shape registration method according to claim 1, further comprising:
a step of fixing each of the positioning members to the subject via a jig for fixing.

15. The three-dimensional shape registration method according to claim 1, wherein in the step of acquiring three-dimensional CT data, when the subject is composed of a plurality of components, the CT data, which is acquired in a state in which at least three positioning members are disposed for each of the components, is acquired.

16. A three-dimensional shape data processing device comprising:
a data acquisition unit that acquires three-dimensional CT data of a subject and at least three positioning members, which are acquired by performing X-ray CT imaging on the positioning members together with the subject;
a relative position information acquisition unit that acquires information on relative positions between the subject and each of the positioning members; and
a registration unit that performs registration between the subject in the CT data and the subject in three-dimensional design data of the subject based on the CT data, the design data, and the information on the relative positions.
